(19) United States
(12) Patent Application Publication
(10) Pub. No.: US 2011/0273437 A1
(43) Pub. Date: Nov. 10, 2011

(54) Data Dependent Method of Configuring Stereoscopic Rendering Parameters

(75) Inventors: Hugh Ross Sanderson, Perth (AU); Steven Robert Pegg, Perth (AU)

(73) Assignee: DYNAMIC DIGITAL DEPTH RESEARCH PTY LTD, Bentley (AU)

(21) Appl. No.: 12/773,465

(22) Filed: May 4, 2010

(51) Int. Cl. G06T 15/00

(52) U.S. Cl. 345/419

(57) ABSTRACT

A method of determining a configuration of stereoscopic rendering parameters in a computer graphics environment by periodically determining the location of data within the viewing frustum and adapting the parameters to generate a stereo render.

### FIELD

A method of determining a configuration of stereoscopic rendering parameters in a computer graphics environment by periodically determining the location of data within the viewing frustum and adapting the parameters to generate a stereo render.

### BACKGROUND

Computer graphics models and games using geometric 3D environments provide a readily accessible form of content for stereoscopic and autostereoscopic display devices. A number of companies have developed stereoscopic drivers that enable 3D applications to directly interface with a stereoscopic display device without modifying the original program. For example, NVIDIA Corp has provided stereoscopic drivers that work in conjunction with their graphics.

In traditional 2D graphics applications a single virtual camera is used to map a 3D scene onto a 2D plane. Stereoscopic game drivers enable the 3D scene to be rendered from multiple viewpoints. The critical aspect, in relation to the current invention is the manner in which the stereoscopic rendering parameters are determined. In the prior art the cameras are configured using some fixed aspect of the 3D environment. Generally, the near and far clipping planes of the viewing frustum define the volume within which the 3D scene is presented to the observer. It is common to use the position of these clipping planes to configure the relative position of the multiple virtual cameras in a stereoscopic display driver. However, this approach leads to sub-optimal stereoscopic 3-D when the data is not evenly distributed within the viewing frustum. That is to say, if the data is concentrated only in one part of the viewing frustum the stereoscopic perception of the 3D scene is poor.

The present invention provides a more optimal mapping between the virtual 3D scene and the stereoscopic viewing volume. This is achieved by configuring the stereoscopic rendering parameters not by reference to some fixed bounds of the virtual 3D scene (such as the clipping planes) but by actively detecting and tracking the data in the viewing frustum and periodically updating the stereoscopic rendering parameters. In addition, rules may be attached to specific rendering tasks to modify the manner in which they are treated in a stereoscopic render. This approach, provides the observer with an enhanced stereoscopic perception of the structure of the virtual 3D environment relative to the techniques used in the prior art.

### BRIEF DESCRIPTION OF THE DRAWINGS

FIG. 1 shows an illustrative stereoscopic driver model;

FIG. 2 shows an illustrative stereoscopic API model;

FIG. 3a shows a perspective view of a viewing frustum according to illustrative aspects of the disclosure;

FIG. 3b shows the viewing frustum of FIG. 3a from a plan view;

FIG. 4 shows a flowchart relating to the generation of 3-D within the driver or API models according to illustrative aspects of the disclosure;

FIG. 5 shows a flowchart describing the process involved in dynamically adjusting the stereo configuration according to illustrative aspects of the disclosure; and

FIG. 6 shows an example of interlaced recomposition, in which each line is alternatively composed of the left and right eye views according to illustrative aspects of the disclosure.

### DETAILED DESCRIPTION

There are two methods for enabling computer games and/or applications to run in stereoscopic 3D:

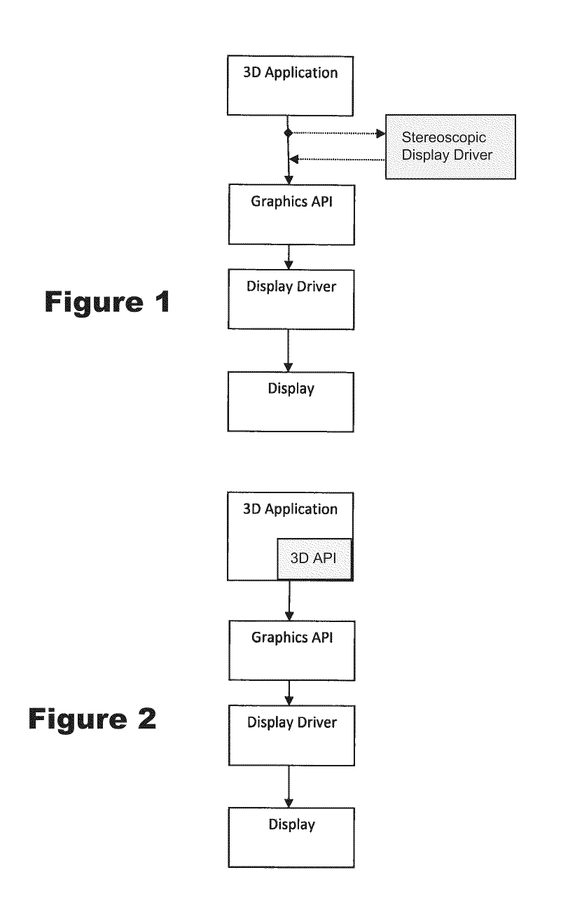

a) “Driver” model: Stereoscopic display driver to intercept 3D application calls between a 3D application and the low level graphics drivers, as shown in FIG. 1; and
b) “API” model: Stereoscopic rendering code integrated into the application itself through a stereoscopic rendering API, as shown in FIG. 2.

The primary advantage of the driver model is that it is possible to provide stereoscopic support for a wide range of existing applications without requiring any changes to the source code of the original applications.

The primary advantage of the API model is that stereoscopic 3D is designed into the game during the design stage leading to a better integration of 2D and 3D effects. The primary objective in the early market development of 3D display technology is to enable as much content in 3D as possible. The driver model is therefore preferable as it is effectively an after market accessory that can enable a large library of existing games to run in stereoscopic 3D.

It is expected that the API model will become more commonplace as the market matures and stereoscopic game support becomes integrated with game development. The current invention, described below, is a core technique for determining improved stereoscopic render parameters that can be used in either driver or an API configuration.

### Stereoscopic Rendering Technique

There are two separate but related techniques for generating stereoscopic images from a 3D scene:

a) Virtual stereoscopic cameras: when mapping a 3D scene to 2D plane a single camera position is positioned in the 3D scene. To generate a stereoscopic view it is necessary to position two or more virtual cameras in the 3D scene. Effectively these virtual cameras simulate the position of the observer's eyes.

b) Depth map acquisition and depth based rendering: An alternative approach is to combine a single camera viewpoint with depth map (or z-buffer). Using techniques derived from the field of image based rendering it is possible to synthesize virtual viewpoints from a single viewpoint and associated depth map.

The depth map approach has a performance advantage. Due to complex nature of 3D scenes rendering a unique viewpoint can be computationally expensive. So in order to avoid the overhead of rendering the scene two or more times for a stereoscopic render it is possible to render the scene once and use the associated depth map to simulate a change in view point by manipulating the pixels of the original viewpoint as a function of the depth map. In addition, it is possible to generate a depth map at a lower resolution for improved efficiency. For example, if the display resolution is 1680×1050 (in pixels) then the depth map may be calculated at 420×525 (one quarter of the display resolution). At the final render stage the depth map is interpolated to the display resolution.

The advantage of using multiple virtual cameras is that the stereoscopic scene is rendered more faithfully, in particular in relation to “occluded” areas. In the depth map approach dis-occluded areas are rendered as holes that need to be filled using interpolation. With a stereo render such holes do not occur.

Regardless of the stereoscopic rendering method employed the fundamental concept is the mapping of data from the viewing frustum into a stereoscopic viewing volume. The current invention provides a means of improving this mapping by determining the position of the data in the 3D viewing frustum. However, the detailed mechanisms for implementing the improved mapping vary depending on the stereoscopic rendering technique used.

### Locating Data in the Viewing Frustum

The first step in the current invention is locating the data within the viewing frustum. The process is the same regardless of the stereoscopic rendering technique used. The objective is to identify the near and far data planes and this information is used to adjust the stereoscopic rendering parameters. The near and far data planes, unlike the clipping planes, are generally unknown to a stereoscopic display driver in a 3D scene and must be determined at regular intervals as the data within the viewing frustum changes.

In the current invention the location of the near and far data can be calculated by examining the z-buffer. If the z-buffer cannot be efficiently accessed directly the location of the near and far data planes are calculating using an occlusion culling method. Occlusion culling is well known to those skilled in art as a method improving render performance by only drawing objects which are visible from the current viewpoint. Popular graphics APIs such as DirectX9 directly support occlusion culling queries. In more modern graphics APIs such as DirectX10 and DirectX11 the z-buffer is more readily accessible and the overhead of occlusion culling to calculate data extents is not required.

The occlusion culling method of determining the minimum and maximum extents of the data in the view frustum involves rendering occlusion culling planes parallel to the near and far clipping planes of the frustum and examining the result of the occlusion culling operation to determine how many pixels are rendered in front of the plane and how many pixels are rendered behind the plane.

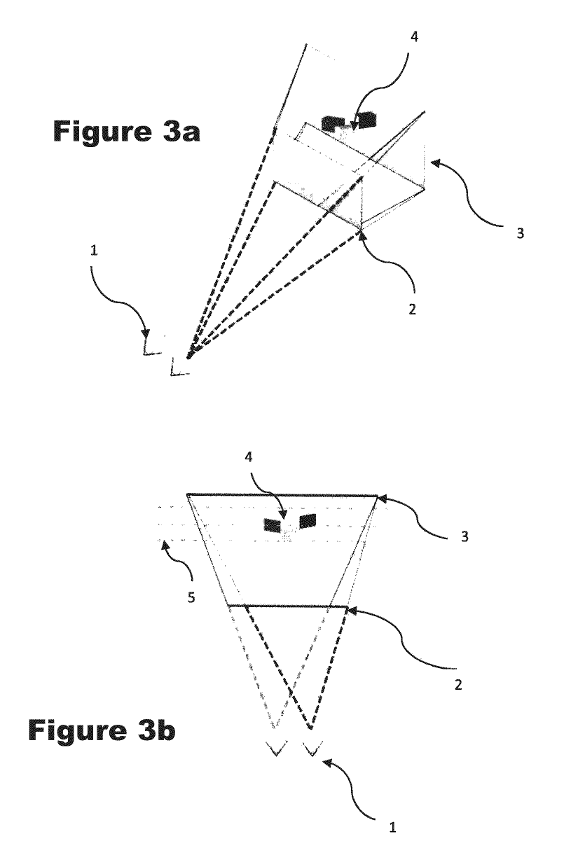

FIG. 3 illustrates the viewing frustum including a virtual stereo camera arrangement 1. The frustum is bounded by the near clipping plane 2 and the far clipping plane 3. The data in the scene is represented by the cubes label 4. FIG. 3a shows the perspective view of the viewing frustum for clarity and FIG. 3b shows the same viewing frustum from a plan view. FIG. 3b also illustrates how occlusion planes 5 (represented by dashed lines in the plan view) are parallel to the clipping planes and locate the data within the bounds of the clipping planes.

It is not necessary to determine the absolute extents of the data distribution in order to effectively enable auto focus. It is sufficient to know where the majority of the data is concentrated in order to generate an improved stereoscopic configuration. For example, the occlusion culling technique may terminate once it has identified the extents of 95% of the data volume. The remaining 5% can be treated as outliers. This can lead to performance improvements, without significantly impacting stereo image quality, as it reduces the number of occlusion culling queries that are necessary.

There are two different modes in which the data location process may operate when using occlusion culling:

### Reset:

When there is no prior knowledge of the data distribution the data location mechanism locates several occlusions planes throughout the range of the z-axis of the viewing frustum. Depending on the mode of operation the results of the initial occlusion planes determine the location of subsequent planes. For example, a method similar to a standard binary search or partition may be used to locate the bulk of the data quickly. That is to say, if the results of an occlusion plane query indicate that more data is behind the plane than in front of the plane subsequent planes will be positioned behind the plane.

### Refine:

During normal operation the data within the viewing frustum will vary gradually for each frame rendered. In these circumstances it is efficient to use the results from previous frames to reduce the number of occlusion queries needed to accurately determine data extents. If there is a sudden scene change then the refined plane queries will indicate spurious results and it is necessary to revert to the reset mode. One or more constant-z planes are rendered using occlusion queries in the vicinity of the previously know near and far data planes. The new near data z can then be calculated from furthest the z-plane that occluded all (or almost all) the scene. Similarly, the new far data z is calculated from the closest z-plane that did not occlude any of the scene.

Configuring Stereo Parameters from the Detected Data Planes

The most important aspect of a stereoscopic render is the horizontal disparity between the left and right eye renders. Disparity essentially represents the shift in viewpoint from the observers left and right eye. Disparity control is the primary method of improving the configuration of a stereoscopic render. If there is too much disparity then the observer has difficulty in fusing the left and right eye image into a 3-D image and eye-strain/headaches can occur. If there is too little disparity then the image appears flat or 2D.

Having determined the location of the data within the viewing frustum it now becomes possible to adjust disparity to ensure that the scene maximizes the use of stereoscopic disparity without exceeding the ability of the observer to fuse the data. The horizontal disparity of a projected point is proportional to the distance from the camera. In a stereo render the horizontal position of a point is modified as a function of the distance from the camera. This modification is generally symmetrical for the left and right eye renders. So for example, if the horizontal position of a point is shifted by 2 for the left eye the shift for the right eye is −2.

In a general sense we can denote:

Dx=a*w;

Where Dx is the horizontal disparity and w is the distance from the camera to the point. In the absence of any knowledge of the location of the data in the viewing frustum the scaling from w to Dx must be arbitrary. Generally, the maximum range of w is used to scale the disparity. That is to say if w varies between 0 and 1 then the scale factor is determined so that at the limit the disparity reaches the maximum desirable value. However, if the data in the scene does not fully cover the range between 0 and 1 the disparity is sub-optimal. For example, if all the data is concentrated at the near clipping plane then range of disparity will be low and the stereoscopic render will appear flat.

Given information about the location of the data in the viewing frustum it becomes possible to improve the disparity range. Given that we have determined the minimum and maximum distance to the camera we can adjust the scaling factor to ensure we get the desired disparity range for the data. It should be noted that the desired maximum horizontal disparity is dependent on the combination of stereoscopic display technology and user preference. The user may set a maximum disparity range for a given display device and the data dependent configuration described above then adjusts the scaling factor a based on the data in the viewing frustum and the users' configuration for the display.

### Focal Point Adjustment

The stereoscopic focal point or point of convergence is the point at which the disparity between the left and the right eye is zero. A stereoscopic render can be configured to include both overall disparity range as well as position of the focal point. Essentially, the disparity range defines the volume within which the stereoscopic data can be rendered and the focal point defines a plane in this volume that represents the point of zero disparity. Anything rendered in front of the focal point appears to be floating in-front of the physical plane of the stereoscopic display device and anything behind the focal point appears to be behind the physical plane of the stereoscopic display device.

The focal point can be placed anywhere in the volume. Within the data dependent framework the focal point can be set using one of two different schemes:

a) User specifies relative placement of focal point within view volume (for example, user requests 20% of content should be in front of the screen).
b) The focal point is set to relate to the data in the center of the screen. This mode is quite useful in first person shooter games in which the center of the screen generally relates to the focus of attention. In this mode it is necessary to specifically calculate the distance to the point at the center of the screen using the methods described in section X.
Configuring a Depth Based Render from Depth Data

When using a depth based render auto focus essentially remaps the absolute depth range into a subset of the overall range that contains the data. For example, if the overall z axis ranges from 0 to 1 and the data location mechanism has identified that the data is concentrated in the range 0.5 to 0.9 then the auto focus mechanism remaps the z-buffer so that any data below 0.5 is mapped to zero, any values above 0.9 are mapped to 1 and the range between 0.5 and 0.9 is linearly mapped from 0.0 to 1.0. In some graphics environments it is not possible to directly access the z-buffer and it is necessary to determine a depth map by using occlusion culling techniques. In this scenario it is convenient to combine the data detection mechanism with a depth map generation mechanism to achieve best performance.

### Rule Based Configuration

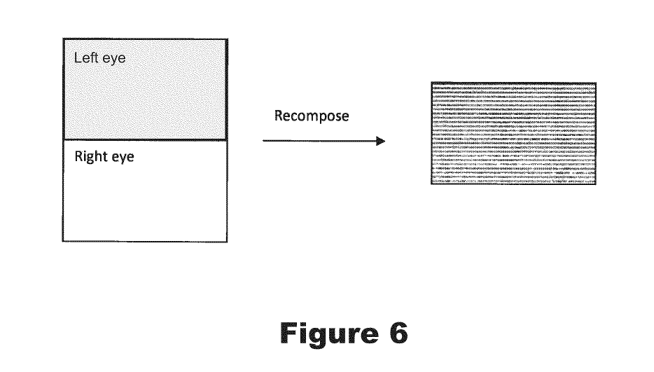

In order to optimize stereoscopic rendering a key decision relates to the ordering of different stages of the render pipeline, in particular, the timing of stereo recomposition. Recomposition is the final step in the generation of a stereoscopic video signal and it involves multiplexing the data from the left and right eye for the 3D display. The exact nature of recomposition varies depending on the stereoscopic display technology. For example, types of recomposition include interlaced and anaglyph. FIG. 6 shows an example of interlaced recomposition, in which each line is alternatively composed of the left and right eye views. In this example, a single stereo buffer contains a full resolution left and right eye arrange above-and-below each other. During recomposition alternative lines are selected from the left eye (top half of the buffer) and right eye (bottom half of the buffer).

In anaglyph recomposition the left and right eye images are combined on the basis of the color channels: the final image is composed of the red channel from one view (left) and the blue and the green channels from the other view (right). The current invention is not limited to any specific recomposition method but applies generally to any method including both stereo and mutli-view recomposition as well as spatial, temporal and color multiplexing.

In a typical computer graphics 3D rendering environment not all render tasks relate to rendering a geometric object located in a virtual space. For example, it is common to use heads-up displays in computer games to provide the user with information such as how much ammunition is remaining, how much health is left or provide the user with a radar or map. Such information is composited on the 3D scene in 2D. It is also common for computer graphics applications to post-process the rendered image once it has been projected on to a 2D plane. For example, anti-aliasing is often used to visually enhance the rendered 3D image using 2D image processing. As such processes can reduce the effectiveness of stereo recompositon it is important that they are handled correctly.

The methods used to identify such render tasks are therefore an integral part of the data dependent method of adjusting the stereoscopic rendering parameters.

In order to handle specific render tasks a sequence of rules are defined. A rule has an associated set of states which are used to identify specific render tasks. The rules also have a set of actions which determine how to handle the render task.

States may include factors such as:
the primitive count of the object is less than 50;
the object is configured to read and/or write from the depth buffer;
the render target of the object has the same resolution as the screen size.

These states are only examples, the current invention relates to a general method of identifying any specific attributes of a render task in order to improve stereoscopic rendering. In the implementation of the software a user interface enables the user to identify specific render tasks visually, query their attributes and assign specific rules to objects as required.

If a render task meets all the defined states then the associated action is executed. Actions include: not performing the render task at all, performing the render task before stereo recomposition; performing the render task after recomposition and/or modifying the render parameters for this object.

The current invention relates to a flexible and extensible system that includes the ability to create new rules as required to optimize 3D effects for each specific game or application. In particular, it is possible to store rules in a separate file and load these rules and associated actions as necessary. These files may be shared across the internet to help new users gain a high quality 3D experience from any game and/or application without needing to adjust the stereo configuration. It is also envisaged that more general rules that apply broadly to all graphics applications are hard coded into a stereoscopic display driver.

Dividing the Scene into Multiple Zones

To provide an improved stereoscopic rendering using auto focus it is advantageous to treat different parts of the scene independently. One of the difficulties in stereoscopic rendering of games is to ensure that both near and distant objects are not rendered with excessive disparity. This is particularly challenging for games that include a gun in the near part of the viewing frustum.

In computer games it is common to use a “sky box” to render distant objects such as sky and background scenery such as mountains. A sky box does not represent the true geometric relationship between objects in the real world but is used as a means of simulating an expansive environment, including elements such as distant mountains and clouds/sky effects.

It is therefore convenient to treat data in the gun zone and the sky box separately from the main scene. This is achieved by detecting or defining parts of the viewing frustum that should be treated as a separate zone for auto focus purposes. For example, the gun zone may occupy the range 1.0 to 25.0 on the z axis, the main scene may occupy the range 70.0 to 100.0 and the sky box is rendered from 100.0 onwards. Each zone is treated independently with occlusion queries used to detect the data planes and related stereo configuration determined in each zone independently.

### Application Profiles

As described above, rules may be associated with specific graphics applications in order to improve the stereoscopic render. In the preferred embodiment these rules are encoded in a separate application profile that can be loaded into the stereoscopic rendering module to optimize the appearance of the application. The Application Profile is also used to store other information, apart from the rule base, including but not limited to:
Configuration parameters for data location:
   The existence and position of zones such as gun zone, sky;
   Parameters defining the speed with which the positions of the near and far data planes can be refined;
Parameters affecting scene change detection: for example, if the camera movement.
Configuration of stereo render parameters: the application profile may indicate whether a depth-based render should be used and if so what resolution the depth map is set to.
The display profile may also store parameters relating to how the stereo render should be scaled for final display: in some cases is it desirable to render the image at a lower resolution to compensate for effects such overscan. If the aspect ratio of the game does not match the aspect ratio of the display the display profile can also store information about how to crop and scale the image to fit on to the display.

### System Flow Charts

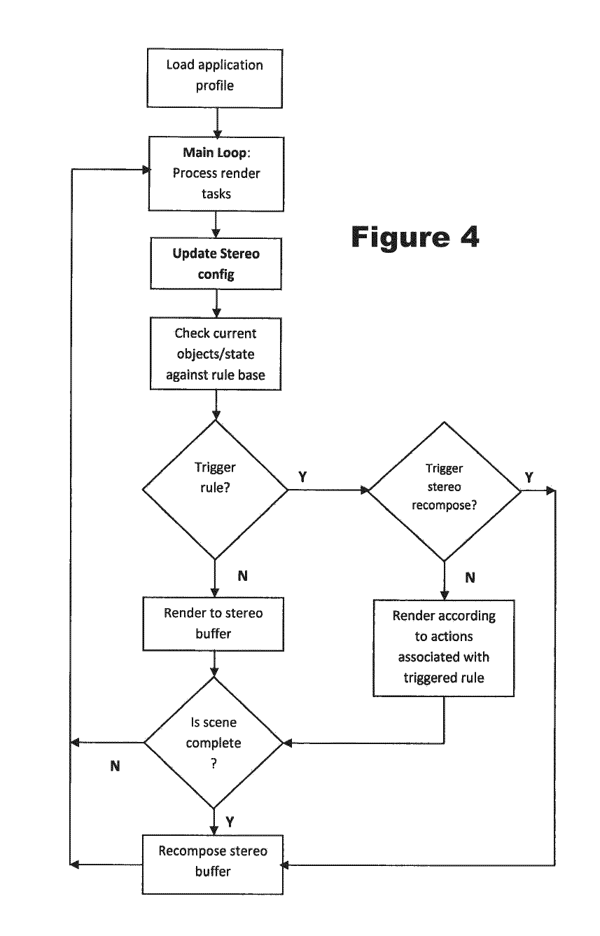

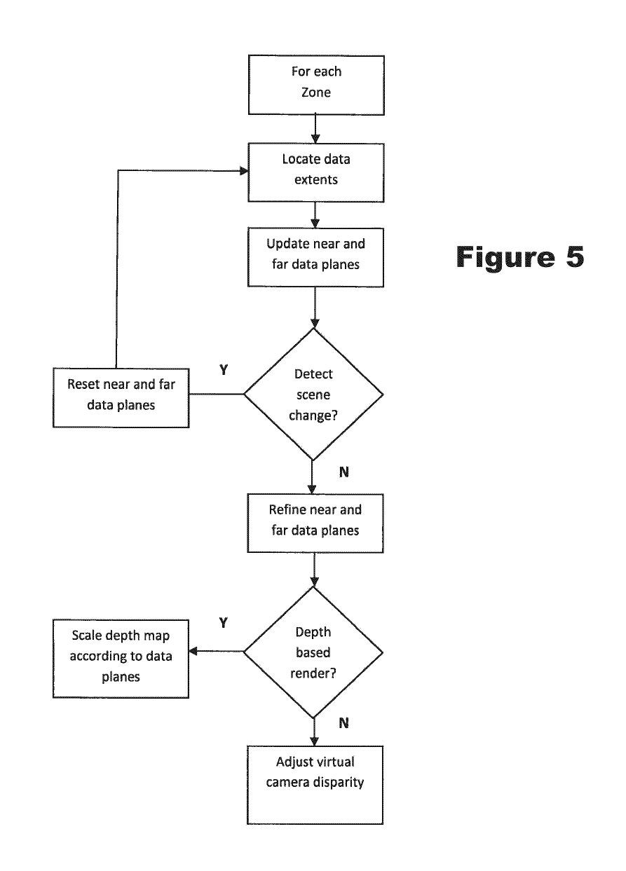

FIG. 4 shows a flowchart relating to the generation of 3-D within the driver or API models. During the start-up phase an application specific profile file is loaded. Once the profile is loaded the driver starts to process render tasks and state changes from the graphics application programming interface (API). The three dimensional graphics objects rendered in the graphics environment are used to update the current stereo configuration as described in more detail in reference to FIG. 5. The current graphics state and objects are examined to determine whether any specific rules are triggered. If there are no specific rules associated with the object or current graphics state then the object is rendered according the default stereo configuration determined in the earlier step. If a rule exists for the current render task then the associated action is used to render the object. An early recompose may be triggered by the graphics state, as described above this occurs when the rendering of 3-D objects is completed and the remaining render tasks relate to the rendering of graphical user interface elements.

FIG. 5 is a flowchart describing the process involved in dynamically adjusting the stereo configuration, which forms a core part of the current invention. Each zone (for example, gun zone, main scene, sky zone) is process separately. The extents of the 3-D objects are determined as previously described using for example, occlusion culling planes. If the data extents change by some pre-determine amount then it is defined as a scene change and process to locate the data extents is reset. Once the position of the near and far planes has been fixed, the stereo configuration is adapted based on the stereo render type. For depth based rendering a scale and offset is applied to the depth map to ensure that the dynamic range of the depth map is maximized over the data extents.

What is claimed is:

1. A method of configuring stereoscopic rendering parameters, including:
locating data in a viewing frustum; and
adjusting the disparity.
